(19) United States
(12) Patent Application Publication
(10) Pub. No.: US 2005/0195951 A1
(43) Pub. Date: Sep. 8, 2005

(54) Custom calling feature disable for restricted calls

(75) Inventor: Mark R. Bunker, Cibolo, TX (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 10/790,473

(22) Filed: Mar. 1, 2004

(51) Int. Cl. H04M 3/42; H04M 3/00; H04M 11/00

(52) U.S. Cl. 379/196; 379/207.02

(57) ABSTRACT

A system for restricting telephone calls that originate from a facility includes at least one facility resident telephone configured to originate and present a call signal, a switching office, and a destination telephone. The at least one facility resident telephone, the switching office, and the destination telephone are electrically serially coupled such that a call signal originating at the at least one facility resident telephone is routed to the destination telephone via the switching office. The switching office disables at least one custom calling feature corresponding to the call signal upon determining the call signal as originating from the at least one facility resident telephone.

### BACKGROUND OF THE INVENTION

1. Field of the Invention

The present invention relates to a system and a method for custom calling feature disable for restricted telephone calls.

2. Background Art

Referring to FIG. 1, a diagram illustrating a conventional telephone system 10 is shown. The system 10 is generally implemented in connection with a prison, jail, mental hospital, rehabilitation center, or similar facility where the telephone calls that are made by the residents (e.g., inmates, patients, etc.) of the facility are to be restricted or limited. Such restrictions and limitations are generally intended to reduce or prevent harassing telephone calls (e.g., to judges, victims, former inmates, witnesses, prison employees, and the like) and fraudulent telephone calls (i.e., calls that improperly charge a third party telephone number for a call made by the resident) from being made by the residents.

The conventional system 10 includes a resident telephone 12 (e.g., a telephone at a prison, jail, etc.), a call processor 14, an originating central office 16, an end office 18 and an end user telephone 20. The resident telephone 12, call processor 14, originating central office 16, end office 18 and end user telephone 20 are electrically serially coupled such that a telephone call that originates at the resident telephone 12 (e.g., CALL) is sent (i.e., presented, transmitted, transferred, etc.) to the end user telephone 22. However, in addition to the phone call CALL being sent to the end user telephone 20, while the CALL is in progress (i.e., any time during the CALL), the end user may make a three way call to a third party telephone 22. Similarly, the resident (e.g., inmate) can set up a call forwarding transfer to a third party telephone. Using the three way call or call forwarding features, the resident can make harassing telephone calls and fraudulent telephone calls.

The normal call flow in the system 10 for an inmate call relies entirely on the inmate call processor 14 to detect a three way call attempt. The conventional scenario allows the inmate call processor 14 to disconnect a call in progress when the inmate call processor 14 senses that an attempt to make a three way call is being made. Because of the detection processes implemented in the inmate call processor 14 and the conventional processes and apparatus used for three way call detection, normal calls are some times terminated even though an attempt to make a three way call was never made.

Conventional approaches use a variety of a implementations that provide call processing for calls made from inmate facilities to detect three way call attempts. Such conventional approaches for inmate calls include silence detection, switch hook noise detection, detection of extra digit dialing, and ring detection. Such conventional approaches for inmate calls have a number of problems and deficiencies. In some cases, some of the conventional approaches fail to detect when a three way call is made. In other examples, some of the conventional approaches terminate calls that should not be terminated.

Furthermore, conventional approaches may be unable to detect the call forwarding feature that is sometimes used by inmates to make free telephone calls. The inmates make telephone calls to end user customers who answer the calls and are unwittingly allowing the inmate to set up call forwarding. The customer does not realize what has been done until telephone bills with unknown and unwanted charges are received. The customers typically contact the telephone service provider to remove the charges which in turn causes lost revenue for the telephone service provider.

Thus, there exists a need for an improved system and an improved method for handling inmate calls. Such an improved system and an improved method may address some or all of the problems and deficiencies of conventional approaches identified above, and provide additional features and advantages as discussed below.

### BRIEF DESCRIPTION OF THE DRAWINGS

The present invention is pointed out with particularity in the appended claims. However, other features of the present invention will become more apparent, and the present invention will be best understood by referring to the following detailed description in conjunction with the accompanying drawings in which:

FIG. 1 is a diagram of a conventional inmate call system;

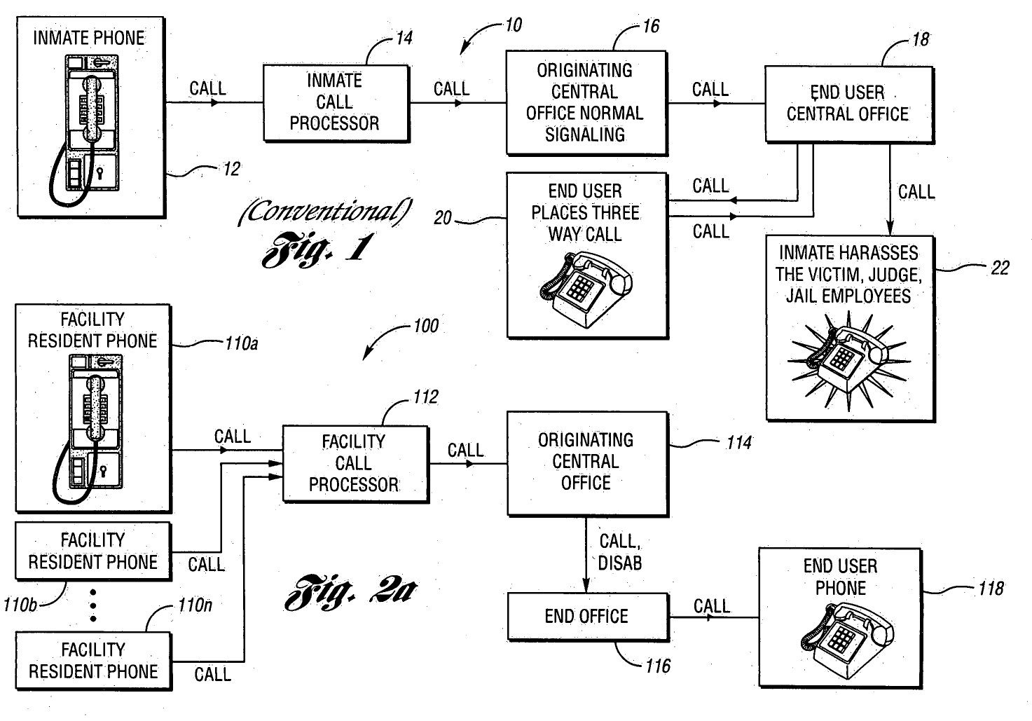

FIGS. 2(a-d) are diagrams of a call restriction system of the present invention; and

FIGS. 3(a-c) are diagrams of alternative implementations of interconnections to a switching office of the present invention.

### DETAILED DESCRIPTION OF THE PREFERRED EMBODIMENT(S)

The present invention generally provides new, improved and innovative techniques for restricting telephone calls that are made from a facility (e.g., inmate calls). The present invention may simply and reliably reduce or prevent inmates from making telephone calls that are subsequently made three way calls and calls that are call forwarded.

According to the present invention, a system for restricting telephone calls that originate from a facility is provided. The system comprises at least one facility resident telephone configured to originate and present a call signal, a switching office, and a destination telephone. The at least one facility resident telephone, the switching office, and the destination telephone are electrically serially coupled such that a call signal originating at the at least one facility resident telephone is routed to the destination telephone via the switching office. The switching office disables at least one custom calling feature corresponding to the call signal upon determining the call signal as originating from the at least one facility resident telephone.

Also according to the present invention, a method for restricting telephone calls that originate from a facility is provided. The method comprises routing a call signal from at least one facility resident telephone configured to originate and present the call signal through a switching office to a destination telephone. The at least one facility resident telephone, the switching office, and the destination telephone are electrically serially coupled. The method further comprises disabling at least one custom calling feature corresponding to the call signal upon determining the call signal as originating from the at least one facility resident telephone.

Further, according to the present invention, a system for restricting telephone calls that originate from a facility is provided. The system comprises at least one facility resident telephone configured to originate and present a call signal, a facility resident call processor, an originating central office, a destination central office, and a destination telephone. The at least one facility resident telephone, the call processor, the originating central office, the destination office, and the destination telephone are electrically serially coupled such that the call signal that originates at the facility resident telephone is routed to the destination telephone. A first control signal is sent from the originating central office to the destination central office when the call signal is presented. The first control signal disables at least one custom calling feature corresponding to the call signal. The at least one custom calling feature is at least one of three way calling and call forwarding. The at least one custom calling feature is disabled only for the duration of the call signal. The at least one custom calling feature is disabled via a Signal System 7 (SS7) telephony protocol. The facility resident call processor generates a second control signal in response to the origination of the call signal. The first control signal is sent from the originating central office in response to the second control signal.

Yet further, according to the present invention, a system for restricting telephone calls that originate from a facility is provided. The system comprises at least one facility resident telephone configured to originate and present a call signal, a facility resident call processor, an originating central office, a destination central office, and a destination telephone. The at least one facility resident telephone, the call processor, the originating central office, the destination office, and the destination telephone are electrically serially coupled such that the call signal that originates at the facility resident telephone is routed to the destination telephone. A first control signal is sent from the originating central office to the destination central office when the call signal is presented. The first control signal disables at least one custom calling feature corresponding to the call signal. The at least one custom calling feature is at least one of three way calling and call forwarding. The at least one custom calling feature is disabled only for the duration of the call signal. The at least one custom calling feature is disabled via a Signal System 7 (SS7) telephony protocol. The originating central office includes a look up table (LUT) containing a database of telephone numbers that correspond to the telephone numbers of the at least one facility resident telephone. The first control signal is sent from the originating central office in response to a match between the telephone numbers in the database and a received telephone call having a telephone number that corresponds to the at least one facility resident telephone.

The above features, and other features and advantages of the present invention are readily apparent from the following detailed descriptions thereof when taken in connection with the accompanying drawings.

With reference to the Figures, the preferred embodiments of the present invention will now be described in detail. Generally, the present invention provides an improved system and an improved method for custom calling feature disabling for telephone calls from a restricted facility (e.g., inmate calls). The present invention may simply and reliably reduce or prevent inmates from making telephone calls that are subsequently made three way calls and calls that are call forwarded. The present invention is generally implemented in connection with a prison, jail, mental hospital, rehabilitation center, or similar facility where the telephone calls that are made by the residents of the facility (e.g., inmates, patients, prisoners, etc.) are to be restricted or limited. The telephone calls from residents at such facilities are generally routed from an inmate telephone through a call processor (e.g., an inmate call processor) to an originating central office, from the originating central office through an end user central office, and from the end user central office to an end user (i.e., destination) telephone.

The present invention generally provides for disabling (i.e., turning off, disarming, stopping, etc.) at least one (and generally all) of the custom calling features on the destination number thereby not permitting (i.e., allowing, enabling, etc.) a three way call to be set up (generated), or, alternatively, a call to be forwarded. The call will generally be unanswered thereby causing the call processor at the inmate facility to inform the inmate to try to make the call later. When the call is answered, the call processor at the inmate facility will prompt the end user to either accept the call or hang up.

In contrast, conventional approaches typically use the inmate processor to attempt to determine when three way calling or call forwarding have been initiated, and terminate the call to the destination number. Such conventional approaches can fail to stop three way calls and forwarded calls that should not be made, and can disable (i.e., stop, terminate, etc.) calls that are not attempts at three way calls and call forwarding that should be left uninterrupted.

The present invention uses signaling sent from the originating central office to the end or (destination) office. The signaling sent from the originating central office generally disables custom calling features only for the duration of the call from the inmate facility. The signaling that is used to disable custom calling features on calls from the inmate facility is generally implemented in connection with a telephony protocol. In one example, Signal System 7 (SS7) telephony protocol may be implemented to disable all custom calling features for the duration of the call. However, any appropriate telephony protocol may be used to disable all custom calling features to meet the design criteria of a particular application. At the end of the call, the custom calling features are reinstated (i.e., set back to normal operation) thereby allowing the end user full functionality of the custom calling features.

Because the present invention provides for temporarily disabling custom calling features for the duration of the call from the inmate (i.e., resident, patient, and the like), deficiencies of the conventional approaches using the inmate call processor for detection of attempted three way calls where calls are terminated in error are eliminated. Furthermore, the present invention may enhance and improve fraud protection by eliminating calls that are forwarded that should not be forwarded as can occur when conventional approaches are used.

While the present invention is described in connection with an inmate telephone call system (e.g., a system as may be implemented in connection with a jail or prison), the present invention may be advantageously implemented in connection with any facility where controlling (e.g., disabling, restricting, limiting, and the like) custom call features (i.e., call forwarding, three way calling from the destination phone, etc.) for calls made from within the facility telephone system is desired. Such facilities may include mental health care facilities (e.g., mental hospitals, so-called half-way houses, etc.), drug rehabilitation centers, a variety of clinics, and the like.

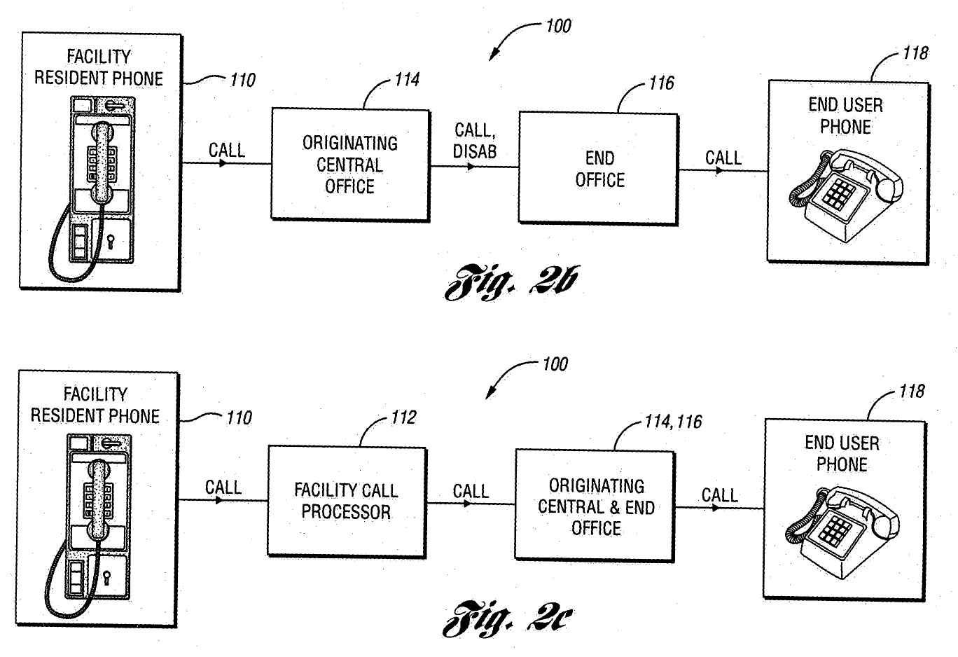

Referring to FIG. 2a, a diagram of a call restriction system 100 of the present invention is shown. The system 100 is generally implemented as an institutional call system. The system 100 is generally implemented as a telephone call restriction system in connection with a prison, jail, or similar facility (i.e., an institution) where the telephone calls that are made by the residents (e.g., inmates, patients, etc.) of the facility are to be controlled (e.g., restricted, limited, etc.). Such restrictions and limitations are generally intended to reduce or prevent harassment of third parties via three way calling from a destination phone, and fraudulent telephone calls that are made by call forwarding to a third party from and charged back to a destination phone from being made by the residents. As discussed above, the residents conventionally make such harassing and fraudulent telephone calls via custom calling features such as call forwarding and three way calling.

The system 100 generally comprises at least one resident (e.g., a facility resident such as an inmate, patient, etc.) telephone 110 (more generally a number of telephones 110a-110n), an inmate facility (or any other restricted facility) call processor 112, an originating central office (e.g., a first switching office) 114, an end (or destination) central (e.g., a second switching office) office 116, and an end user (destination) telephone 118. The telephone 110, facility call processor 112, originating central office 114, end office 116 and end user telephone 118 are electrically serially coupled such that a telephone call that originates at the resident telephone 110 (e.g., CALL) is sent (i.e., routed, presented, transmitted, transferred, etc.) to the end user telephone 118.

When a telephone call (e.g., a signal CALL) is initiated (e.g., generated, originated, started, made, etc.) at the inmate telephone 110, the signal CALL is generally routed to the call processor 112. The telephone call signal CALL may be routed from the call processor 112 to the originating central office 114. The telephone call signal CALL may be routed from the originating central office (switching office) 114 to the end (destination) central office 116. The destination central office (switching office) 116 generally routes the telephone call signal CALL to the end user telephone 118. The switching office 114 disables at least one custom calling feature corresponding to the call signal CALL upon determining the call signal as originating from the at least one facility resident telephone 110.

The present invention may also provide for a signal (e.g., DISAB) to be presented by the originating central office 114 to the end (destination) central office 116 when a telephone call (e.g., the signal CALL) is initiated (i.e., generated, originated, sent, made, etc.) from the inmate telephone 110. The signal DISAB is generally implemented as a control signal that is configured to provide for temporarily (e.g., for the duration of the call from the inmate) disabling custom calling features. The switching office (e.g., the office 114 disables at least one custom calling feature corresponding to the call signal CALL upon determining (i.e., recognizing, acknowledging, etc.) that the telephone call signal CALL originated from the facility resident phone 110.

The signal DISAB is generally implemented in connection with at least one telephony protocol. In one example, the signal DISAB is implemented via Signal System 7 (SS7) telephony protocol. However, any appropriate telephony protocol may be used to disable all custom calling features to meet the design criteria of a particular application. At the end of the telephone call from the inmate call processor 112 (e.g., when the signal CALL is deactivated), the custom calling features are reinstated (i.e., set back to normal operation) at the destination office 116 (i.e., the respective destination office for the telephone 118) thereby providing the end user full functionality of the custom calling features when using the telephone 118.

The SS7 protocol comprises a protocol stack having several parts. The parts of the SS7 stack include a message transfer part (MTP), an ISDN user part (ISUP), a telephone user part (TUP), a signaling connection protocol part (SCCP), a transaction capabilities applications part (TCAP), and an operations, maintenance and administration part (OMAP). At least one of the parts (e.g., the MTP) may carry the signal DISAB. A message in the SS7 protocol is generally referred to as a signal unit (SU). Three types of SUs are used. The three types of SUs are fill-in signal units (FISUs), link signal units (LSSUs), and message signal units (MSUs). At least one of the types of SUs (e.g., the MSUs) generally carries the signal DISAB.

Referring to FIG. 2b, a diagram of an alternative call system 100 of the present invention is shown. The system 100 may be implemented having the facility resident telephone 110 coupled directly to the switching office 114. The features that are implemented in the facility call processor 112 may be implemented in connection with (i.e., integrated into) the originating switching office 114.

Referring to FIG. 2c, a diagram of another alternative call system 100 of the present invention is shown. The system 100 may be implemented having the originating switching office 114 and the end user switching office 116 integrated as one switching office 114, 116 (i.e., the originating office and the end office may be the same switching office). For example, the telephone call signal CALL may be placed to a destination telephone 118 that is in a region having telephone service that is local to the facility where the telephone 110 is located. The signal DISAB may provide for temporarily disabling custom calling features related to (i.e., corresponding to, associated with, etc.) the signal CALL internally within the switching office 114, 116.

Referring to FIG. 2d, a diagram of yet another alternative call system 100 of the present invention is shown. The system 100 may be implemented having the facility resident telephone 110 coupled directly to a switching office 114, 116. The features that are implemented in the facility call processor 112 may be implemented in connection with (i.e., integrated into) the switching office 114, 116. The originating switching office 114 and the end user switching office 116 may be integrated as one switching office 114, 116 (i.e., the originating office and the end office may be the same switching office). The signal DISAB may provide for temporarily disabling custom calling features related to (i.e., corresponding to, associated with, etc.) the signal CALL internally within the switching office 114, 116.

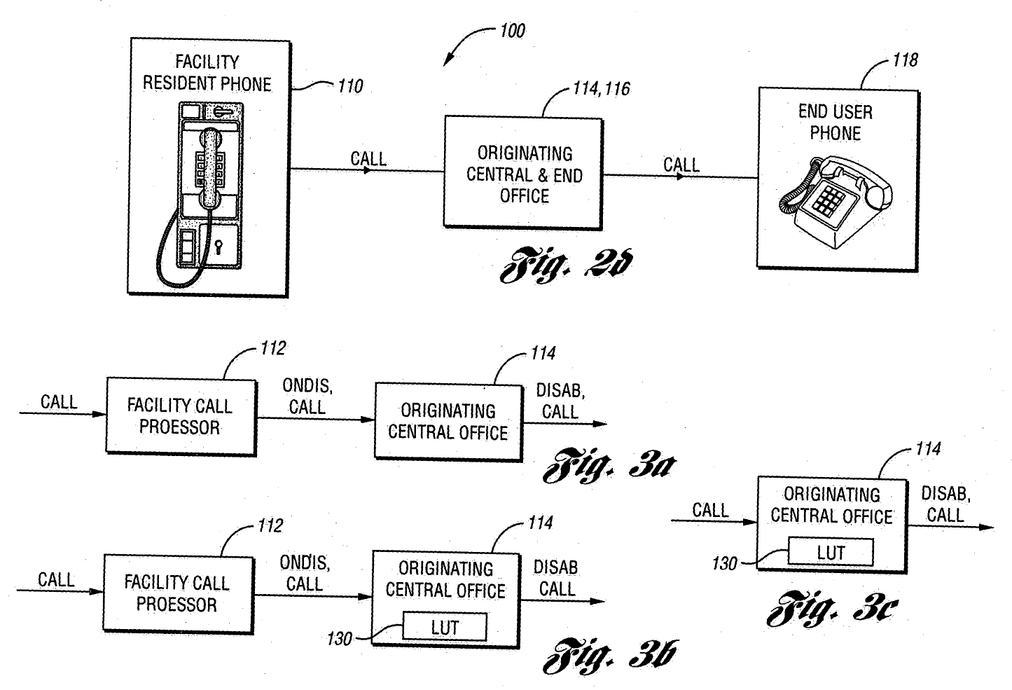

Referring to FIG. 3a, a diagram illustrating an example implementation of the call processor 112 and the originating central office 114 is shown. As described above in connection with FIGS. 2(c-d), the switching office 114 may include the destination switching office 116. The facility call processor 112 may be configured (e.g., programmed, wired, set up, etc.) to present a signal (e.g., ONDIS) when a resident initiates a telephone call (e.g., the signal CALL) from the telephone 110. The signal ONDIS is generally implemented as a control signal.

The signal ONDIS (and the signal CALL) may be presented to the originating central office 114. The originating central office 114 may be configured to present the signal DISAB in response to the signal ONDIS. The call processor 112 and the switching office 114 shown in FIG. 3a may be advantageously implemented in connection with the system 100 as shown in FIGS. 2a and 2c.

Referring to FIG. 3b, a diagram illustrating another example implementation of the inmate call processor 112 and the originating central office 114 is shown. As described above in connection with FIGS. 2(c-d), the switching office 114 may include the destination switching office 116. The originating central office 114 may include a processor having a look up table (LUT) 130. The LUT 130 may contain (i.e., hold, store, etc.) a database of telephone numbers that correspond to the telephone numbers having restricted usage (e.g., at least one telephone number corresponding to the telephone 110).

When an inmate initiates a telephone call (e.g., the signal CALL is presented to the central office 114 via the processor 112), the central office 114 may read the LUT 130 to determine if the originating telephone has restricted usage (i.e., there is a match between the originating telephone number and at least one telephone number stored in the LUT 130 that corresponds to a telephone 110). When there is a match (i.e., the central office 114 determines that the originating telephone is a telephone 110), the central office 114 generates the signal DISAB. That is, the central office 114 is configured to generate the signal DISAB in response to receiving a telephone call (e.g., the signal CALL) from a telephone having restricted usage (e.g., the telephone 110). The switching office 114 shown in FIG. 3b may be advantageously implemented in connection with the system 100 as illustrated in FIGS. 2a and 2c.

Referring to FIG. 3c, a diagram illustrating another example implementation of the originating central office 114 is shown. As described above in connection with FIGS. 2(c-d), the switching office 114 may include the destination switching office 116. The originating central office 114 may include a processor having a look up table (LUT) 130. The switching office 114 shown in FIG. 3c may be advantageously implemented in connection with the system 100 as illustrated in FIGS. 2b and 2d.

As is readily apparent from the foregoing description, then, the present invention generally provides an improved system and method for controlling (e.g., disabling) custom calling features for telephone calls from a restricted facility (e.g., inmate calls). The present invention may simply and reliably reduce or prevent call restricted facility residents (e.g., inmates) from making telephone calls that are subsequently made three way calls and calls that are call forwarded.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A system for restricting telephone calls that originate from a facility, the system comprising:
at least one facility resident telephone configured to originate and present a call signal;
a switching office; and
a destination telephone, wherein the at least one facility resident telephone, the switching office, and the destination telephone are electrically serially coupled such that a call signal originating at the at least one facility resident telephone is routed to the destination telephone via the switching office, and wherein the switching office disables at least one custom calling feature corresponding to the call signal upon determining the call signal as originating from the at least one facility resident telephone.

2. The system of claim 1 wherein the at least one custom calling feature is three way calling.

3. The system of claim 1 wherein the at least one custom calling feature is call forwarding

4. The system of claim 1 wherein the at least one custom calling feature is disabled only for the duration of the call signal.

5. The system of claim 1 wherein the at least one custom calling feature is disabled via a telephony protocol.

6. The system of claim 5 wherein the telephony protocol is Signal System 7 (SS7) telephony protocol.

7. The system of claim 1 wherein the at least one custom calling feature is disabled in response to a first control signal that is generated upon determining the call signal as originating from the at least one facility resident telephone.

8. The system of claim 7 further comprising an end office that is electrically serially coupled between the switching office and the destination telephone, wherein switching office generates the first control signal and presents the first control signal to the end office, and the end office disables the at least one custom calling feature.

9. The system of claim 8 further comprising a facility call processor electrically serially coupled between the at least one facility resident telephone and the switching office, wherein the facility call processor generates a second control signal in response to the origination of the call signal, and the first control signal is sent from the switching office in response to the second control signal.

10. The system of claim 1 wherein the switching office includes a look up table (LUT) containing a database of telephone numbers that correspond to the telephone numbers of the at least one facility resident telephone, and the at least one custom calling feature is disabled in response to a match between the telephone numbers in the database and a received telephone call having a telephone number that corresponds to the at least one facility resident telephone.

11. The system of claim 1 wherein the facility is at least one of a jail, a prison, a drug rehabilitation center, and a mental hospital, and the facility resident is at least one of a inmate, a prisoner, and a patient.

12. A method for restricting telephone calls that originate from a facility, the method comprising:
routing a call signal from at least one facility resident telephone configured to originate and present the call signal through a switching office to a destination telephone, wherein the at least one facility resident telephone, the switching office, and the destination telephone are electrically serially coupled; and
disabling at least one custom calling feature corresponding to the call signal upon determining the call signal as originating from the at least one facility resident telephone.

13. The method of claim 12 wherein the at least one custom calling feature is three way calling.

14. The method of claim 12 wherein the at least one custom calling feature is call forwarding

15. The method of claim 12 wherein the at least one custom calling feature is disabled only for the duration of the call signal.

16. The method of claim 12 wherein the at least one custom calling feature is disabled via a telephony protocol.

17. The method of claim 16 wherein the telephony protocol is Signal System 7 (SS7) telephony protocol.

18. The method of claim 12 wherein the at least one custom calling feature is disabled in response to a first control signal that is generated upon determining the call signal as originating from the at least one facility resident telephone.

19. The method of claim 18 further comprising electrically serially coupling an end office between the switching office and the destination telephone, wherein switching office generates the first control signal and presents the first control signal to the end office, and the end office disables the at least one custom calling feature.

20. The method of claim 19 further comprising electrically serially coupling a facility call processor between the at least one facility resident telephone and the switching office, wherein the facility call processor generates a second control signal in response to the origination of the call signal, and the first control signal is sent from the switching office in response to the second control signal.

21. The method of claim 12 wherein the switching office includes a look up table (LUT) containing a database of telephone numbers that correspond to the telephone numbers of the at least one facility resident telephone, and the first control signal is sent from the originating central office in response to a match between the telephone numbers in the database and a received telephone call having a telephone number that corresponds to the at least one facility resident telephone.

22. The method of claim 12 wherein the facility is at least one of a jail, a prison, a drug rehabilitation center, and a mental hospital, and the facility resident is at least one of a inmate, a prisoner, and a patient.

23. A system for restricting telephone calls that originate from a facility, the system comprising:
at least one facility resident telephone configured to originate and present a call signal;
a facility resident call processor;
an originating central office;
a destination central office; and
a destination telephone, wherein the at least one facility resident telephone, the call processor, the originating central office, the destination office, and the destination telephone are electrically serially coupled such that the call signal that originates at the facility resident telephone is routed to the destination telephone, and a first control signal is sent from the originating central office to the destination central office when the call signal is presented, and wherein the first control signal disables at least one custom calling feature corresponding to the call signal, the at least one custom calling feature is at least one of three way calling and call forwarding, the at least one custom calling feature is disabled only for the duration of the call signal, the at least one custom calling feature is disabled via a Signal System 7 (SS7) telephony protocol, the facility resident call processor generates a second control signal in response to the origination of the call signal, and the first control signal is sent from the originating central office in response to the second control signal.

24. A system for restricting telephone calls that originate from a facility, the system comprising:
at least one facility resident telephone configured to originate and present a call signal;
a facility resident call processor;
an originating central office;
a destination central office; and
a destination telephone, wherein the at least one facility resident telephone, the call processor, the originating central office, the destination office, and the destination telephone are electrically serially coupled such that the call signal that originates at the facility resident telephone is routed to the destination telephone, and a first control signal is sent from the originating central office to the destination central office when the call signal is presented, and wherein the first control signal disables at least one custom calling feature corresponding to the call signal, the at least one custom calling feature is at least one of three way calling and call forwarding, the at least one custom calling feature is disabled only for the duration of the call signal, the at least one custom calling feature is disabled via a Signal System 7 (SS7) telephony protocol, the originating central office includes a look up table (LUT) containing a database of telephone numbers that correspond to the telephone numbers of the at least one facility resident telephone, and the first control signal is sent from the originating central office in response to a match between the telephone numbers in the database and a received telephone call having a telephone number that corresponds to the at least one facility resident telephone.
